(19) United States
(12) Patent Application Publication
(10) Pub. No.: US 2018/0208779 A1
(43) Pub. Date: Jul. 26, 2018

(54) Thermally Insulating Coatings for Polymer Substrates

(71) Applicant: The Texas A&M University System, College Station, TX (US)

(72) Inventors: Jaime Christopher Grunlan, College Station, TX (US); Chaoqun Zhang, Xiaochi Town (CN)

(21) Appl. No.: 15/416,019

(22) Filed: Jan. 26, 2017

(51) Int. Cl. C09D 5/18; C09D 105/08; C09D 7/12; B05D 1/02; B05D 1/18; B05D 1/28

(52) U.S. Cl. CPC C09D 5/18; C09D 105/08; B05D 1/28; B05D 1/02; B05D 1/18; C09D 7/1216

(57) ABSTRACT

A coating for protecting a metal substrate from corrosion comprising a first composition applied on or over the metal substrate and a second composition applied on or over the first composition. The first composition is positioned between the second composition and the metal substrate, the first composition includes a first layer directly applied on or over the metal substrate and a second layer directly applied on or over the first layer, and the first layer of the first composition is positioned between the second layer of the first composition and the metal substrate. The first layer of the first composition comprises positively charged polymers and the second layer comprises negatively charged polymers and the second composition comprises positively charged polymers and negatively charged silicate clay.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

The disclosure relates generally to fire resistant, thermal barriers thermally-resistant for protecting components exposed to relatively high thermal energies. More particularly, the disclosure relates to slurry cast thermally-resistant coatings for protecting polymer substrates from thermal damage.

A significant portion of fire-related injuries and damage occur in the home and in connection with transportation vehicles such as cars and airplanes. For example, components in a vehicle positioned near an internal combustion engine (e.g., near a jet engine of an airplane) experience relatively high thermal loads. If not adequately shielded or protected from the thermal loads, such components may be damaged and/or catch fire. One conventional technique for protecting components from thermal energy is to simply position such components at a greater distance from the source of the thermal energy. However, this technique necessitates the availability of space, which may be limited, particularly in aerospace applications. Other conventional techniques for protecting components from thermal energy include manufacturing such components from more exotic, fire resistant materials, and attaching fire resistant panel to such components. However, such techniques can increases costs (materials and manufacturing costs) and add weight, which is also undesirable in many aerospace applications.

### BRIEF SUMMARY OF THE DISCLOSURE

In an embodiment, a method for manufacturing a thermally-resistant component, the method comprising: forming a first homogenous coating solution by mixing a first aqueous solution including an cationic polymer and a second aqueous solution including an anionic clay; and applying the first homogenous coating solution to a first side of a substrate.

In an embodiment, a thermally-resistant component, comprising: a polymeric substrate; and a thermally insulating coating mounted to the substrate, wherein the coating comprises a mixture of one or more cationic polymers and one or more anionic clays.

Embodiments described herein comprise a combination of features and advantages intended to address various shortcomings associated with certain prior devices, systems, and methods. The foregoing has outlined rather broadly the features and technical advantages of the invention in order that the detailed description of the invention that follows may be better understood. The various characteristics described above, as well as other features, will be readily apparent to those skilled in the art upon reading the following detailed description, and by referring to the accompanying drawings. It should be appreciated by those skilled in the art that the conception and the specific embodiments disclosed may be readily utilized as a basis for modifying or designing other structures for carrying out the same purposes of the invention. It should also be realized by those skilled in the art that such equivalent constructions do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1A is a schematic partial cross-sectional view of an embodiment of a thermally-resistant coating in accordance with principles described herein;

FIG. 1B is a schematic partial cross-sectional view of an embodiment of a thermally-resistant coating in accordance with principles described herein;

FIG. 2A is a schematic partial cross-sectional view of an embodiment of a thermally-resistant coating in accordance with principles described herein;

FIG. 2B is a schematic partial cross-sectional view of an embodiment of a thermally-resistant coating in accordance with principles described herein;

FIG. 3A is a schematic partial cross-sectional view of an embodiment of a thermally-resistant coating in accordance with principles described herein;

FIG. 3B is a schematic partial cross-sectional view of an embodiment of a thermally-resistant coating in accordance with principles described herein;

FIG. 4A is a schematic partial cross-sectional view of an embodiment of a thermally-resistant coating in accordance with principles described herein;

FIG. 4B is a schematic partial cross-sectional view of an embodiment of a thermally-resistant coating in accordance with principles described herein;

FIG. 5 is a flow chart illustrating an embodiment of a method in accordance with the principles described herein for manufacturing thermally-resistant coatings disclosed herein;

FIG. 6 illustrates chemical structures of exemplary materials chitosan (CH), montmorillonite (MMT), and vermiculite (VMT) that can be used to form embodiments of the thermally-resistant described herein;

FIG. 7 illustrates an exemplary experimental apparatus for testing the flame resistance of embodiments of thermally-resistant coatings described herein;

FIGS. 8A-8D are photographs of samples fabricated in accordance with embodiments described herein after being subjected to a burn test;

FIG. 9 illustrates an exemplary experimental apparatus for testing embodiments of thermally-resistant coatings described herein;

FIGS. 10A and 10B are graphic illustrations of the heat treatments performed on uncoated and on coated samples fabricated in accordance with embodiments described herein;

FIGS. 11A-11D illustrate the results of drying cycles that were employed in the formation of thermally-resistant coatings fabricated in accordance with embodiments described herein;

FIGS. 12A and 12B illustrate the uncoated samples (FIG. 12B) disposed in a furnace at 430° C. for varying times and coated samples (FIG. 12A) fabricated in accordance with embodiments described herein and disposed in a furnace at 430° C. for varying times;

FIG. 13 is a graphical illustration of the weight % loss of uncoated samples after heat treatment;

FIG. 14 is a graphical illustration of the weight % of the coated samples as a function of the weight of the substrate plus the coating for coatings fabricated in accordance with embodiments described herein;

FIG. 15 illustrates the heat treatment and burn through results of heat treated samples including thermally-resistant CH/MMT coatings in accordance with embodiments described;

FIG. 16 is a graphical illustration of the conditions and results of double-coated thermally-resistant coating samples fabricated in accordance with embodiments described;

FIGS. 17A and 17B are photographs of the front and back sides of double-side coated samples 5% CH-95% MMT (17A) and 7% CH-93% MMT (17B) fabricated in accordance with embodiments described;

FIGS. 18A-18D illustrate the as-coated trilayers of CH(12%)-MMT/MMT(12%)/CH(12%)-MMT (18A); CH(12%)-MMT/VMT(12%)/CH(12%)-MMT (18B); CH(12%)-VMT/MMT(12%)/CH(12%)-VMT (18C); CH(12%)-VMT/VMT(12%)/CH(12%)-VMT (18D) fabricated in accordance with embodiments described;

FIG. 19 illustrates the thermal barrier testing performed on the samples described in FIGS. 18A-18D; and

FIGS. 20A-20D illustrate the front and back sides of the samples of CH(12%)-MMT/MMT(12%)/CH(12%)-MMT (20A); CH(12%)-MMT/VMT(12%)/CH(12%)-MMT (20B); CH(12%)-VMT/MMT(12%)/CH(12%)-VMT (20C); CH(12%)-VMT/VMT(12%)/CH(12%)-VMT (20D) fabricated in accordance with embodiments described.

### DETAILED DESCRIPTION OF THE PREFERRED EMBODIMENTS

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection, or through an indirect connection via other devices, components, and connections. In addition, as used herein, the terms “axial” and “axially” generally mean along or parallel to an axis (e.g., central axis of a body or a port), while the terms “radial” and “radially” generally mean perpendicular to the axis. For instance, an axial distance refers to a distance measured along or parallel to the central axis, and a radial distance means a distance measured perpendicular to the central axis.

Discussed herein are embodiments of thermally-resistant barriers or coatings, as well as methods for applying such coatings, for polymer substrates. Such thermally-resistant coatings and methods enable tailorable properties, decreased coating times, and use in connection with a variety of substrates including polymers, metals, and ceramics. In general, the substrates described herein may be 2D or 3D components that can be coated on one or more sides, faces, or surfaces. In addition, the manufacture and application of embodiments of the thermally-resistant barriers and coatings described herein can be scaled up for mass production. For example, embodiments described herein can be applied to components used in or near internal combustion engines such coated components are not only resistant to and protected from anticipated thermal loads, but are also fire resistant. Such fire-resistance may, for example, not only exhibit improved thermal resistance properties during normal use, but also advantageously enable continued operation of vehicles (e.g., airplanes) despite an engine fire.

In various embodiments, a coating comprising at least one anionic component and at least one cationic component is applied to at least one side of a polymeric substrate. In some embodiments, non-ionic components may be included, these may include polymers such as poly(vinyl alcohol) instead of or in addition to chitosan. The coating is applied as an aqueous, homogenous solution formed from a first aqueous solution of one or more cationic polymers (e.g., chitosan) and a second aqueous solution of one or more anionic clay (e.g., vermiculite (VMT), sodium montmorillonite (MMT), etc.). In some embodiments, the cationic polymers employed exhibit a charring property such as polysaccharides that comprise at least one nitrogen groups. For example, while chitosan is discussed herein, the cationic polymer employed in various embodiments of the present disclosure may comprise other polysaccharides that comprise ring structures and nitrogen groups. In general, embodiments of thermally-resistant coatings described herein can be applied directly to a substrate (e.g., polymer substrate) by spraying, roll-to-roll coating technology such as a blade coating, dip coating, or other suitable method. In addition, the coatings can be applied to one or both sides of the substrate as desired. In some embodiments, a primer layer such as polyethylenimine (PEI) or poly(acrylic) acid (PAA) is applied to the substrate prior to the application of the thermally-resistant coating. Still further, embodiments of thermally-resistant coatings described herein can be applied as a single layer in one application step, or applied in multiple layers in multiple application steps. In embodiments where more than one layer is applied to the substrate, an intermediate drying step can be performed between the application of each layer.

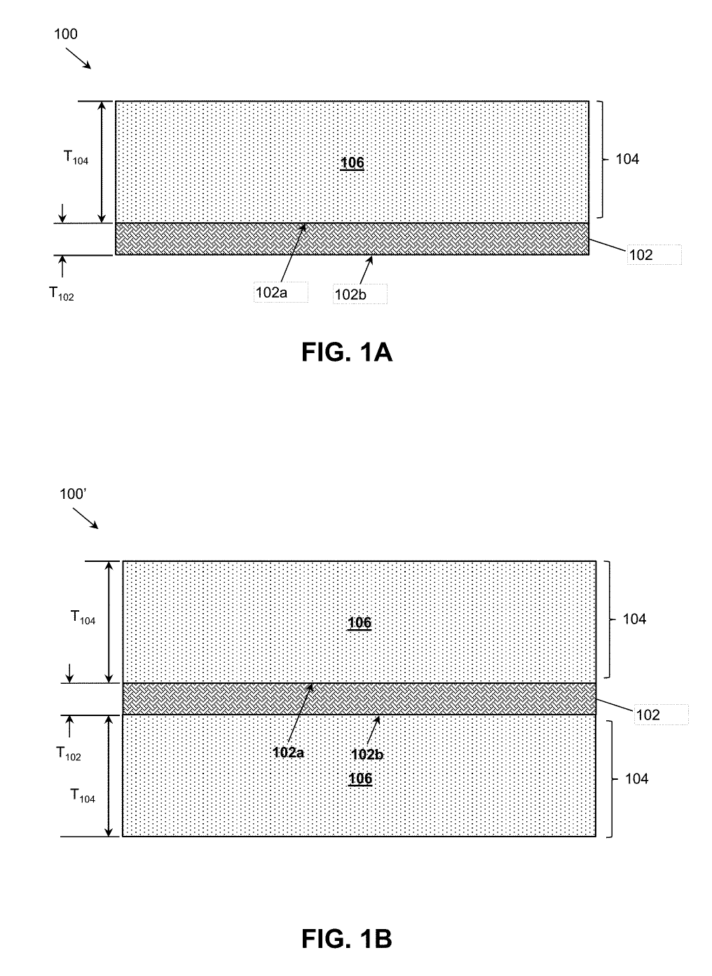

Referring now to FIG. 1A, a schematic partial cross-section view of an embodiment of a structure 100 manufactured in accordance with the principles described herein is shown. In this embodiment, structure 100 includes a thermally-resistant, heat insulating layer or coating 104 applied to a substrate 102. In general, substrate 102 can be any component, part, or structure to be protected from thermal energy by coating 104. For example, substrate 102 can be a component positioned near an internal combustion engine (e.g., jet engine). In addition, the substrate 102 can be made of any type of material that is susceptible to damage resulting from exposure to excessive thermal energy including, without limitation, metals and metal alloys (e.g., aluminum, aluminum alloys, stainless steel, etc.), non-metals (e.g., polymers), and composites (e.g., fiberglass, carbon fiber and epoxy composite, etc.). Although heat insulating coating 104 can be used to insulate and protect substrates 102 made of a variety of different materials, embodiments of coating 104 described herein are particularly suitable for insulating sheets of polymers and composite materials such as fiberglass, Nomex fibers with matrix resins, graphite fibers with matrix resins, and ceramic fibers with matrix resins. Polymer matrix materials could include polyimide, epoxy and/or other temperature-resistant polymers. In the embodiment shown in FIG. 1A, the substrate 102 comprises a sheet of material, and in particular, a sheet of honeycomb material as described in U.S. Pat. No. 8,733,500, which is hereby incorporated herein by reference in its entirety for all purposes. Accordingly, substrate 102 has opposite, parallel sides 102a, 102b. In this embodiment, coating 104 is only applied to one side 102a in FIG. 1A. In such embodiments, coating 104 is preferably applied to side 102a that faces the heat source.

Coating 104 is made of a composition 106 including a homogenous, uniform mixture of one or more cationic (or non-ionic) polymer(s) and one or more anionic clay(s). In embodiments described herein, each of the one or more cationic polymer(s) is preferably a cationic polysaccharide selected from chitosan, cellulose, or starch. The cationic polymer could also be a nitrogen-rich polyelectrolyte, such as polyethylenimine, polyallylamine, polyvinylamine or copolymers containing them. Non-ionic polymers could include polyvinyl alcohol, polyvinylpyrrolidone and polyethylene oxide. In some embodiments, to facilitate charring (as opposed to igniting) when exposed to relatively high thermal energy, one or more of the selected cationic polymers preferably includes at least one nitrogen group per repeat unit. In addition, in embodiments described herein, each of the one or more anionic clay(s) is preferably selected from montomotillonite (MMT) clay (e.g., natural untreated sodium montmorillonite), vermiculite (VMT) clay (e.g., natural vermiculite), kaolinite, halloysite, sepioloite, bentonite, or other inorganic silicate-based materials. Composition 106 preferably comprises 3 to 50 wt % of the one or more cationic polymers and 50 to 97 wt % of the anionic clay(s) when the coating is dried. As will be described in more detail below, coating 104 can be formed by applying composition 106 as a single layer in one application step or by applying composition 106 via multiple layers in a plurality of application steps.

Coating 104 has a thickness T₁₀₄ measured perpendicular to the surface 102a of substrate 102 on which coating 104 is applied, and substrate 102 has a thickness T₁₀₂ measured perpendicularly from side 102a to opposite side 102b. The thickness T₁₀₄ is preferably selected to provide the desired thermal resistance, which may vary from application to application. In embodiments described herein, the thickness T₁₀₄ is preferably greater than 0.001 mm, and more preferably 0.01 mm to 0.1 mm. In addition, the ratio of the thickness T₁₀₄ of coating 104 to the thickness T₁₀₂ of substrate 102 is preferably between 1:10 and 1:1. In some embodiments, the weight of coating 104 is up to about 20% of the weight of the underlying substrate 102.

In the embodiment shown in FIG. 1A, coating 104 is only applied to one side 102a of substrate 102. However, in other embodiments, the coating (e.g., coating 104) can applied to both sides of the underlying substrate (e.g., both sides 102a, 102b of substrate 102). For example, referring now to FIG. 1B, an embodiment of a structure 100′ including a coating 104 of composition 106 applied to both sides 102a, 102b of substrate 102 is shown. Coatings 104, composition 106, and substrate 102 are each as previously described. In addition, the thickness T₁₀₄ of each coating 104, the ratio of the thickness T₁₀₄ of each coating 104 to the thickness T₁₀₂ of substrate 102, and the weight of each coating 104 relative to the weight of substrate 102 are each as previously described. In general, thickness T₁₀₄ of each coating 104 can be the same or different. As will be described in more detail below, each coating 104 can be formed by applying composition 106 as a single layer in one application step or by applying composition 106 via multiple layers in a plurality of application steps.

As shown in FIG. 1B, coatings 104 are disposed on each side 102a, 102b of substrate 102 without being in contact. However, it should be appreciated that coatings 104 may be one contiguous layer or layers that extend around the lateral edges or sides of substrate 102.

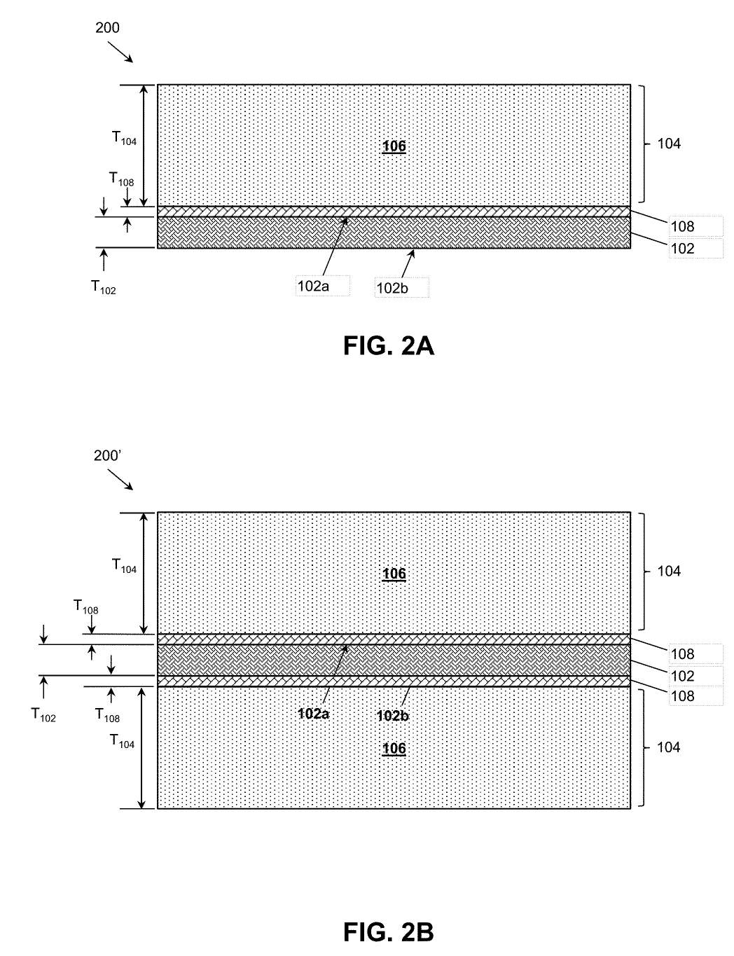

Referring now to FIG. 2A, a schematic partial cross-section of a structure 200 made in accordance with the principles described herein is shown. Structure 200 is substantially the same as structure 100 previously described. Namely, structure 200 includes substrate 102 and coating 104 applied to one side 102a of structure 102. Substrate 102 and coating 104 are each as previously described. In addition, coating 104 is made of composition 106 as previously described. However, unlike structure 100 previously described in which coating 104 was applied directly to substrate 102 (i.e., coating 104 directly contacts and engages side 102a of substrate 102), in this embodiment, a pretreatment or primer layer 108 is positioned between substrate 102 and coating 104. Thus, primer layer 108 is applied directly onto side 102a of substrate 102 (i.e., primer layer directly contacts and engages side 102a of substrate 102), and coating 104 is applied onto primer layer 108 (i.e., coating 104 directly contacts and engages primer layer 108).

In this embodiment, primer layer 108 is made of at least one of linear polyethylenimine (L-PEI), branched polyethylenimine (B-PEI), or poly(acrylic acid) (PAA). The primer could simply be a thin layer (0.01-10 micron thick) of polyethylenimine alone. The primer serves to promote strong adhesion between the protective coating and the substrate to be protected. Primer layer 108 can be applied as a single layer in one application step or applied via multiple layers in a plurality of application steps. Coating 104 and substrate 102 have thicknesses T₁₀₄, T₁₀₂, respectively, each as previously described. Thus, thickness T₁₀₄ is preferably greater than 0.001 mm, and more preferably 0.01 mm to 0.1 mm. Further, the ratio of the thickness T₁₀₄ of coating 104 to the thickness T₁₀₂ of substrate 102 is preferably between preferably between 1:10 and 1:1. Primer layer 108 has a thickness T₁₀₈ measured perpendicular to the surface 102a of substrate 102 on which layer 108 is applied. Thickness T₁₀₈ is preferably greater than 0.00001 mm, and more preferably 0.0001 mm to 0.01 mm.

In the embodiment shown in FIG. 2A, coating 104 and corresponding primer layer 108 are only applied to one side 102a of substrate 102. However, in other embodiments, the coating (e.g., coating 104) and a corresponding primer layer (e.g., primer layer 108) can applied to both sides of the underlying substrate (e.g., both sides 102a, 102b of substrate 102). For example, referring now to FIG. 2B, an embodiment of a structure 200′ including a coating 104 of composition 106 and a corresponding primer layer 108 applied to both sides 102a, 102b of substrate 102 is shown. Coatings 104, composition 106, substrate 102, and primer layers 108 are each as previously described. In addition, the thickness T₁₀₄ of each coating 104, the ratio of the thickness T₁₀₄ of each coating 104 to the thickness T₁₀₂ of substrate 102, the weight of each coating 104 relative to the weight of substrate 102, the thickness T₁₀₈ of each primer layer 108, and the ratio of the thickness T₁₀₈ of each primer layer 108 to the thickness T₁₀₂ of substrate 102, and the ratio of the thickness T₁₀₈ of each primer layer 108 to the thickness T₁₀₄ of the corresponding coating 104 is each as previously described. In general, thickness T₁₀₄ of each coating 104 can be the same or different, and further, the thickness T₁₀₈ of each primer layer 108 can be the same or different. As will be described in more detail below, each primer layer 108 can be applied as a single layer in one application step or by applying composition 106 via multiple layers in a plurality of application steps, and further, each coating 104 can be formed by applying composition 106 as a single layer in one application step or by applying composition 106 via multiple layers in a plurality of application steps.

As shown in FIG. 2B, coatings 104 and primer layers 108 are disposed on opposite sides 102a, 102b of substrate 102 without being in contact. However, it should be appreciated that coatings 104 and primer layers 108 disposed on opposite sides 102a, 102b may be one contiguous layer or layers that extend around the lateral edges or sides of substrate 102.

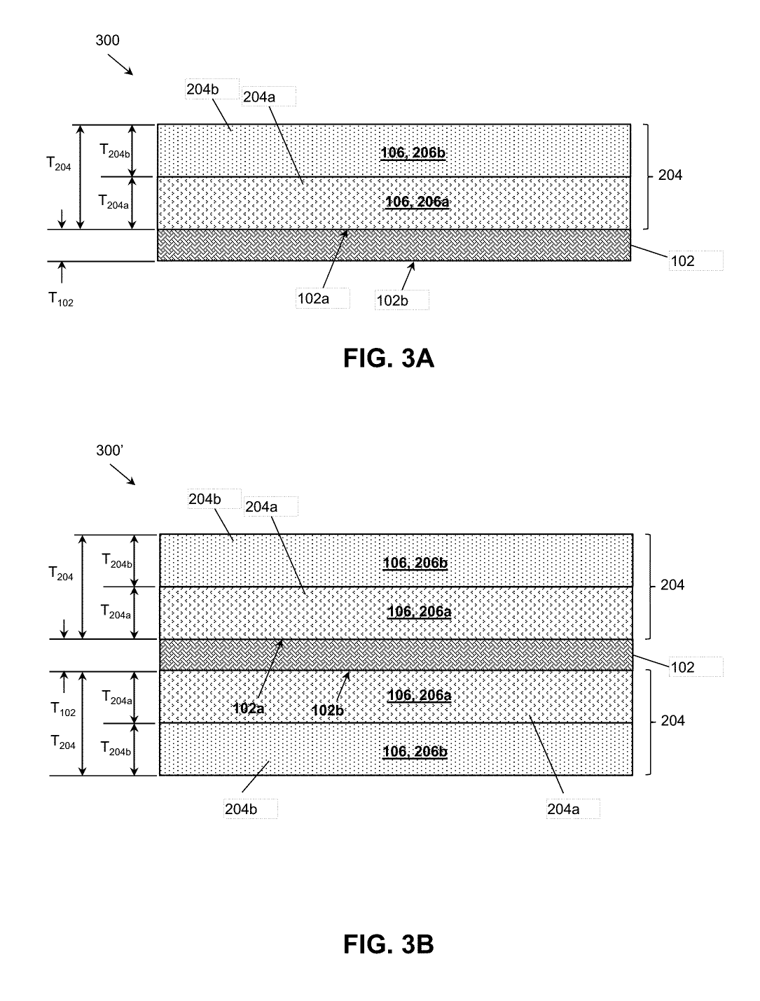

Referring now to FIG. 3A, a schematic partial cross-section of a structure 300 made in accordance with the principles described herein is shown. Structure 300 is substantially the same as structure 100 previously described. Namely, structure 300 includes substrate 102 and a thermal insulating coating 204 applied to one side 102a of structure 102. However, unlike structure 100 previously described in which thermal insulating coating 104 was made of a single, uniform, homogeneous composition 106, in this embodiment, thermal insulating coating 204 comprises a plurality of discrete layers 204a, 204b. Each layer 204a, 204b comprises a different uniform, homogenous composition 206a, 206b, respectively. Each composition 206a, 206b is a different composition 106 as previously described. More specifically, each composition 206a, 206b comprises a homogenous, uniform mixture of one or more cationic polymer(s) and one or more anionic clay(s)—each of the one or more cationic polymer(s) is preferably a cationic polysaccharide selected from chitosan, nitrogen-containing polyelectrolyte or non-ionic polymer chitosan, cellulose, or starch. The cationic polymer could also be a nitrogen-rich polyelectrolyte, such as polyethylenimine, polyallylamine, polyvinylamine or copolymers containing them. Non-ionic polymers could include polyvinyl alcohol, polyvinylpyrrolidone and polyethylene oxide. In an embodiment, each of the one or more anionic clay(s) is preferably selected from montomotillonite (MMT) clay (e.g., natural untreated sodium montmorillonite), vermiculite (VMT) clay (e.g., natural vermiculite), kaolinite, halloysite, sepioloite, bentonite, or other inorganic silicate-based materials. However, the combination of cationic polymer(s) and anionic clay(s) in each composition 206a, 206b are different. Thus, composition 206a of layer 204a may comprise at least one of: 1) a different cationic polymer than composition 206b of layer 204b; 2) a different anionic clay than composition 206b of layer 204b; 3) the same cationic polymer as composition 206b of layer 204b but in a different concentration; 4) the same anionic clay as composition 206b of layer 204b but in a different concentration; 5) a different combination of cationic polymers than composition 206b of layer 204b; 6) a different combination of anionic clays than composition 206b of layer 204b; or combinations thereof. For example, in one embodiment, composition 206a forming layer 204a is a uniform, homogenous mixture of chitosan and MMT and the composition 206b forming layer 204b is a uniform, homogeneous mixture of chitosan and VMT.

Coating 204 (including the plurality of layers 204a, 204b) has a thickness T₂₀₄ measured perpendicular to side 102a to which it is applied, and substrate 102 has a thicknesses T₁₀₂ as previously described. Similar to thickness T₁₀₄ previously described, thickness T₂₀₄ is preferably greater than 0.001 mm, and more preferably 0.01 mm to 0.1 mm. Further, the ratio of the thickness T₂₀₄ of coating 204 to the thickness T₁₀₂ of substrate 102 is preferably between 1:1 and 1:10. Each layer 204a, 204b of coating 204 has a thickness T₂₀₄ₐ, T_{204b}, respectively, and each thickness T₂₀₄ₐ, T_{204b} is preferably greater than 0.0005 mm, and more preferably 0.005 mm to 0.05 mm. In general, the thickness T₂₀₄ₐ, T_{204b} of each layer 204a, 204b can be the same or different. Further, the weight of coating 204 is up to about 20% of the weight of the underlying substrate 102.

In general, each layer 204a, 204b of coating 204 can be formed by applying composition 206a, 206b, respectively, as a single layer in one application step or by applying composition 206a, 206b, respectively, via multiple layers in a plurality of application steps. Although only two layers 204a, 204b are shown in FIG. 3A and described above, in other embodiments, the thermal insulating coating (e.g., coating 204) includes more than two layers (e.g., more than two layers 204a, 204b) mounted to the substrate (e.g., substrate 102).

In the embodiment shown in FIG. 3A, thermal insulating coating 204 comprising multiple layers 204a, 204b is only applied to one side 102a of substrate 102. However, in other embodiments, a thermal insulating coating comprising multiple layers (e.g., coating 204) can applied to both sides of the underlying substrate (e.g., both sides 102a, 102b of substrate 102). For example, referring now to FIG. 3B, an embodiment of a structure 300′ including a coating 204 comprising multiple discrete layers 204a, 204b applied to both sides 102a, 102b of substrate 102 is shown. Layers 204a, 204b comprise compositions 206a, 206b, respectively. Coatings 204, layers 204a, 204b, compositions 206a, 206b, and substrate 102 are each as previously described. In addition, the thickness T₂₀₄ of each coating 204, the thickness T₂₀₄ₐ, T_{204b} of each layer 204a, 204b, respectively, the ratio of the thickness T₂₀₄ of each coating 204 to the thickness T₁₀₂ of substrate 102, and the weight of each coating 204 relative to the weight of substrate 102 are each as previously described. In general, the thickness T₂₀₄ₐ, T_{204b} of each layer 204a, 204b can be the same or different, and the thickness T₂₀₄ of each coating 204 can be the same or different.

In general, each layer 204a, 204b of each coating 204 can be formed by applying composition 206a, 206b, respectively, as a single layer in one application step or by applying composition 206a, 206b, respectively, via multiple layers in a plurality of application steps. Although only two layers 204a, 204b are shown in each coating 204 in FIG. 3A and described above, in other embodiments, one or both thermal insulating coating (e.g., coating 204) includes more than two layers (e.g., more than two layers 204a, 204b) mounted to the substrate (e.g., substrate 102).

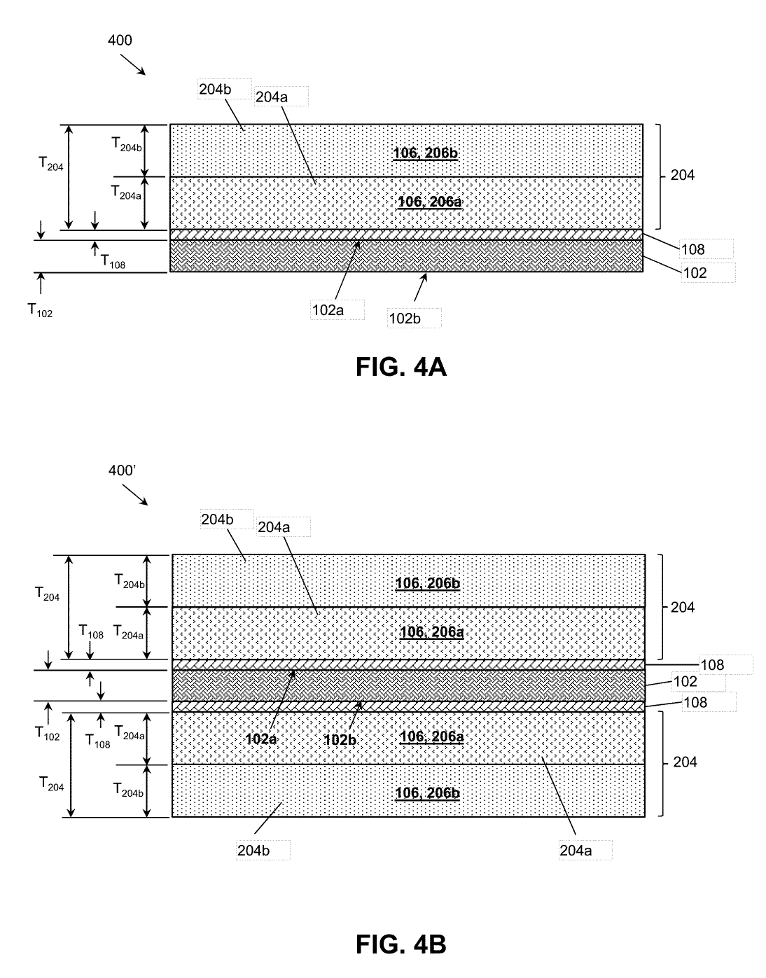

Referring now to FIG. 4A, a schematic partial cross-section of a structure 400 made in accordance with the principles described herein is shown. Structure 400 is substantially the same as structure 300 previously described. Namely, structure 400 includes substrate 102 and coating 204 applied to one side 102a of structure 102. Substrate 102 and coating 204 are each as previously described. In addition, layers 204a, 204b of coating 204 are made of compositions 206a, 206b, respectively, as previously described. However, unlike structure 300 previously described in which coating 204 was applied directly to substrate 102 (i.e., coating 204 directly contacts and engages side 102a of substrate 102), in this embodiment, a pretreatment or primer layer 108 is positioned between substrate 102 and coating 204. Thus, primer layer 108 is applied directly onto side 102a of substrate 102 (i.e., primer layer directly contacts and engages side 102a of substrate 102), and coating 204 is applied onto primer layer 108 (i.e., coating 104 directly contacts and engages primer layer 108).

Primer layer 108 is as previously described. Namely, primer layer 108 is made of at least one of linear polyethylenimine (L-PEI), branched polyethylenimine (B-PEI), or poly(acrylic acid) (PAA). In general, primer layer 108 can be applied as a single layer in one application step or applied via multiple layers in a plurality of application steps.

Coating 204 has a thickness T₂₀₄, substrate 102 has a thickness T₁₀₂, and each layer 204a, 204b of coating 204 has a thickness T₂₀₄ₐ, T_{204b}, each as previously described. Thus, thickness T₂₀₄ is preferably greater than 0.001 mm, and more preferably 0.01 mm to 0.1 mm. Further, the ratio of the thickness T₂₀₄ of coating 204 to the thickness T₁₀₂ of substrate 102 is preferably between 1:1 and 1:10. Each layer 204a, 204b of coating 204 has a thickness T₂₀₄ₐ, T_{204b}, respectively, and each thickness T₂₀₄ₐ, T_{204b} is preferably greater than 0.0005 mm, and more preferably 0.005 mm to 0.05 mm. In general, the thickness T₂₀₄ₐ, T_{204b} of each layer 204a, 204b can be the same or different.

Primer layer 108 has a thickness T₁₀₈ as previously described. Thus, thickness T₁₀₈ is preferably greater than 0.00001 mm, and more preferably 0.0001 mm to 0.01 mm. The weight of coating 204 is up to about 20% of the weight of the underlying substrate 102.

In general, each layer 204a, 204b of coating 204 can be formed by applying composition 206a, 206b, respectively, as a single layer in one application step or by applying composition 206a, 206b, respectively, via multiple layers in a plurality of application steps. In addition, primer layer 108 can be applied as a single layer in one application step or applied via multiple layers in a plurality of application steps. Although only two layers 204a, 204b are shown in FIG. 4A and described above, in other embodiments, the thermal insulating coating (e.g., coating 204) includes more than two layers (e.g., more than two layers 204a, 204b) mounted to the substrate (e.g., substrate 102).

In the embodiment shown in FIG. 4A, coating 204 and corresponding primer layer 108 are only applied to one side 102a of substrate 102. However, in other embodiments, the coating (e.g., coating 204) and a corresponding primer layer (e.g., primer layer 108) can applied to both sides of the underlying substrate (e.g., both sides 102a, 102b of substrate 102). For example, referring now to FIG. 4B, an embodiment of a structure 400′ including a coating 204 and a corresponding primer layer 108 applied to both sides 102a, 102b of substrate 102 is shown. Coatings 204, compositions 106a, 106b of each coating 204, substrate 102, and primer layers 108 are each as previously described. In addition, the thickness T₂₀₄ of each coating 204, the thickness T₂₀₄ₐ, T_{204b} of each layer 204a, 204b, respectively, the ratio of the thickness T₂₀₄ of each coating 104 to the thickness T₁₀₂ of substrate 102, the thickness T₁₀₈ of each primer layer 108, the ratio of the thickness T₁₀₈ of each primer layer 108 to the thickness T₁₀₂ of substrate 102, the ratio of the thickness T₁₀₈ of each primer layer 108 to the thickness T₁₀₄ of the corresponding coating 104, and the weight of each coating 104 relative to the weight of substrate 102 is each as previously described.

In general, thickness T₂₀₄ of each coating 204 can be the same or different, and further, the thickness T₁₀₈ of each primer layer 108 can be the same or different. Each layer 204a, 204b of each coating 204 can be formed by applying composition 206a, 206b, respectively, as a single layer in one application step or by applying composition 206a, 206b, respectively, via multiple layers in a plurality of application steps. In addition, each primer layer 108 can be applied as a single layer in one application step or applied via multiple layers in a plurality of application steps. Although only two layers 204a, 204b are shown in each coating 204 in FIG. 4B and described above, in other embodiments, one or both thermal insulating coating (e.g., coating 204) includes more than two layers (e.g., more than two layers 204a, 204b) mounted to the substrate (e.g., substrate 102).

In various embodiments, substrates may be coated on one or both sides with the following layers, where the X % is the weight percentage of the component in a dried coating. Some example trilayer formulations that may be disposed on one or both sides of a substrate, or otherwise disposed on a 3-dimensional component may comprise: (1) CH(12%)-MMT/MMT(12%)/CH(12%)-MMT; (2) CH(12%)-MMT/VMT(12%)/CH(12%)-MMT; CH(12%)-VMT/MMT(12%)/CH(12%)-VMT; or (3) CH(12%)-VMT/VMT(12%)/CH(12%)-VMT.

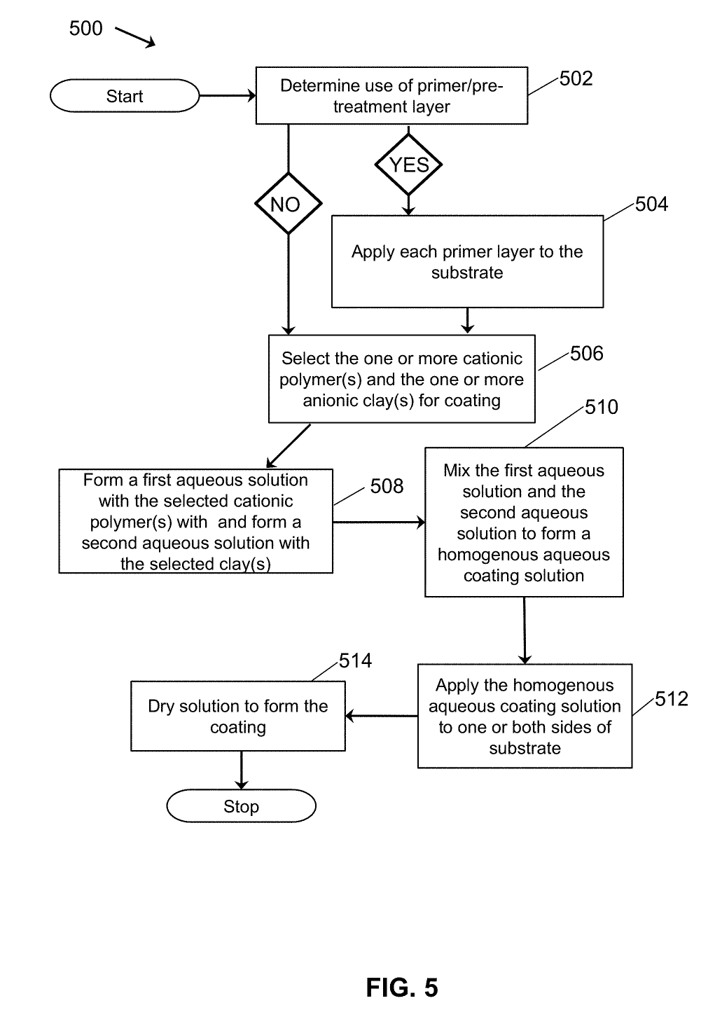

Referring now to FIG. 5, an embodiment of a method 500 for manufacturing embodiments of the structures including thermal insulating coatings (e.g., structures 100, 100′, 200, 200′, 300, 300′, 400, 400′) is shown. In this embodiment, method 500 begins at block 502 where a determination is made as to whether to use a primer or pretreatment layer 108 on one or both sides 102a, 102b of a substrate 102. As previously described, substrate 102 may be an engine component or other component that needs to be thermally insulated to protect it from excessive heat. Moving now to block 504, if it is determined in block 502 that a primer layer 108 is desired, the primer layer 108 is applied to at least one side of the substrate 102. In this embodiment, the pretreatment layer 108 may be applied by dip coating or some type of blade coating. On the other hand, if it is determined in block 502 that a primer layer 108 is not desired, method 500 proceeds from block 502 to block 506, where the one or more positively charged (cationic) polymer(s) and the one or more negatively charged (anionic) clay(s) for the coating 104, 204 are selected. As previously described, in embodiments described herein, each of the one or more cationic polymer(s) is preferably a cationic polysaccharide selected from chitosan, cellulose, or starch. The cationic polymer could also be a nitrogen-rich polyelectrolyte, such as polyethylenimine, polyallylamine, polyvinylamine or copolymers containing them. Non-ionic polymers could include polyvinyl alcohol, polyvinylpyrrolidone and polyethylene oxide. In some embodiments, to facilitate charring (as opposed to igniting) when exposed to relatively high thermal energy, one or more of the selected cationic polymers preferably includes at least one nitrogen group per repeat unit. In addition, in embodiments described herein, each of the one or more anionic clay(s) is preferably selected from montomotillonite (MMT) clay (e.g., natural untreated sodium montmorillonite), vermiculite (VMT) clay (e.g., natural vermiculite), kaolinite, halloysite, sepioloite, bentonite, or other inorganic silicate-based materials.

Referring still to FIG. 5 and moving to block 508, a first aqueous solution including the one or more selected cationic polymer(s) is formed and a second aqueous solution including the one or more selected anionic clay(s) is formed. In particular, the first aqueous solution is formed in block 508 by mixing the one or more selected cationic polymer(s) deionized water and the second aqueous solution is formed in block 508 by mixing the one or more selected anionic clay(s) with deionized water. In embodiments described herein, the first aqueous solution preferably comprises 15 wt. % to about 60 wt. % of the cationic polymer(s), and the second aqueous solution preferably comprises 1.5 wt. % to about 45 wt. % of the anionic clay(s). In one embodiment, the first aqueous solution is an aqueous solution of chitosan having a pH of about 6.0. At block 510, the first aqueous solution and the second aqueous solution are mixed together at block 508 to form a homogenous aqueous coating solution. It should be appreciated that the phrase “coating solution” is used to describe the aqueous solution that is applied to the substrate (or primer layer disposed on the substrate) to form the thermal insulating coating.

In embodiments where a primer layer 108 is applied at block 504, the homogenous aqueous coating solution formed at block 510 is applied to one or both sides 102a, 102b of the substrate 102 directly on top of the primer layer 108 (i.e., the pretreatment layer 108 is applied directly onto the substrate 102 and the homogenous aqueous coating solution is subsequently applied to the primer layer 108). However, in embodiments where no primer layer 108 is applied at block 504, the homogenous aqueous coating solution formed at block 510 is directly applied to one or both sides 102a, 102b of the substrate 102. In general, the application of the homogenous aqueous coating solution at block 510 can be performed by roll-to-roll coating methods referred to as “blade coating” or by dip coating such that both sides 102a, 102b of substrate are coated simultaneously, or the homogenous aqueous coating solution can be applied by an optimized spray process to coat one or both sides 102a, 102b. Depending upon the method employed at block 510, both sides 102a, 102b of the substrate 102 may be coated simultaneously, or each side 102a, 102b of the substrate 102 may have one or more layers applied in one or more process steps to form the completed structure.

Moving now to block 514, to form embodiments of coatings 104 previously described, the homogenous aqueous coating solution is allowed to dry (air dried at room temperature or at an elevated temperature) to form thermal insulating coating 104. In some embodiments, the thermal insulating coating 104 is formed by applying the homogenous aqueous coating solution in multiple layers. In such embodiments, the drying at block 514 is performed after each layer of the homogenous aqueous coating solution is applied at block 512. The application of the homogenous aqueous coating solution can be performed on one or both sides 102a, 102b at a time and then allowed to dry. The coating solution may be applied as discussed herein in a single step, in a single layer, or it may be applied in multiple steps in a single process in multiple layers, and there may or may not be intermediate drying steps employed. The coating solution may be applied by roll-to-roll application (blade coating), spraying, and/or dipping. In some embodiments, the coating may be applied to both sides of a substrate and/or to multiple sides of a structure.

Referring still to FIG. 5, and in particular blocks 508-514, to form embodiments of coatings 104 previously described, more than one aqueous solution of selected cationic polymer(s) and more than one aqueous solution of selected anionic clay(s) is formed in block 508; each of the aqueous solution of selected cationic polymer(s) is mixed with one of the aqueous solution of selected anionic clay(s) in block 510 to form a homogenous aqueous coating solution; and the different homogenous aqueous coating solutions are applied one at a time in the same manner as previously described in blocks 512, 514.

While preferred embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

To further illustrate various illustrative embodiments of the present invention, the following examples are provided.

Natural vermiculite (VMT) (formulation HTS-SE) was purchased from Specialty Vermiculite (Enoree, S.C.). Southern Clay Products, Inc. (Gonzales, Tex.) supplied natural, untreated sodium montmorillonite (MMT) (tradename Cloisite NA+). The MMT platelets had a density of 2.86 g/cm³, an average diameter of 300-800 nm, and a thickness of about 1 nm. Cationic chitosan (CH) (M=60,000 g/mol, 95% deacetylated) was purchased from G.T.C. Union Group (Qingdao, China). 2 wt % MMT and VMT solutions were made with 18.2MΩ deionized (DI) water and rolled overnight for full dissolution. 0.2 wt % CH solution was made using pH 2 DI water and readjusted to pH 5 using sodium hydroxyl.

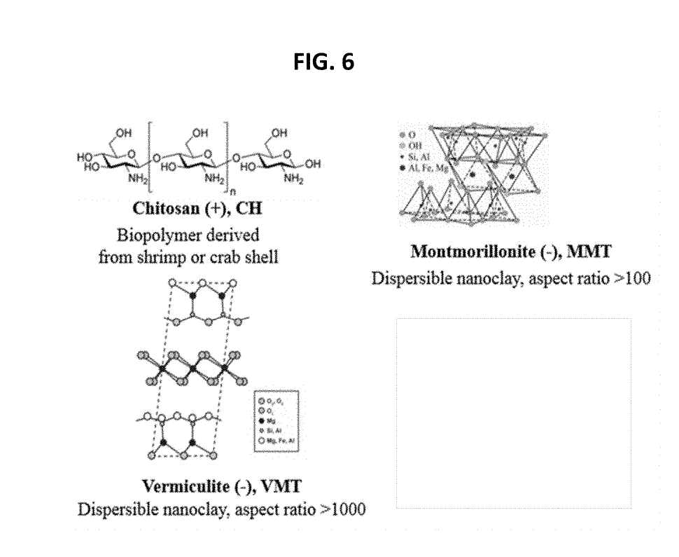

FIG. 6 shows chemical structure of exemplary materials chitosan (CH), montmorillonite (MMT), and vermiculite (VMT) that may be used to form the coating, which was applied in solution to polyimide laminate substrates in some examples discussed herein.

In an embodiment, and as illustrated in the desired aqueous cationic and anionic solutions were prepared to form a homogenous coating solution. In various embodiments, each of the chitosan (cationic), MMT, and VMT materials were mixed with water to form separate aqueous solutions. Both MMT and VMT are discussed herein as the anionic components, and the resultant solutions when those components were mixed with deionized water may be collectively referred to as anionic aqueous solutions. The desired amounts of each of the chitosan and one of the MMT and VMT were mixed together to form a single, homogeneous coating solution. This homogenous coating solution was applied by casting or spraying the mixture into a mold with the polymide laminate substrates inside.

While polyimide laminate substrates were used herein, in other examples, other polymer substrates may be used. These substrates may be hollow, solid, comprise perforations and/or through-holes, or comprise a core structure of a different composition. The samples were dried at room temperature after application of the coating in order to evaporate the water from the coating solution. In alternate embodiments, an oven or other thermal source could be used to accelerate this step. In some embodiments, a pretreatment layer of PEI or PAA may be applied to the substrate prior to the application of the coating. In an embodiment, the weight % of chitosan in a dried coating was less than 13% when MMT was used in combination with the chitosan.

In various embodiments, the experiment was repeated using different concentrations of MMT and chitosan, as well as VMT and chitosan as discussed further below. Table 1 comprises the coating recipes investigated and the difference weight gain among and between the various compositions.

TABLE 1

| Weight of .2 wt | Weight of .2 wt | | Theoretical |
|---|---|---|---|
| % CH solution | % MMT solution | Weight | wt. % of CH |
| used (g) | used (g) | gain (%) | in coating |
| 1.8 | 17.8 | 20 | 1 |
| 5.1 | 18.49 | 25 | 3 |
| 10.11 | 19.21 | 19.7 | 5 |
| 13.29 | 17.66 | 21.2 | 7 |
| 3.19 | 31.58 | 28.8 | 1 |
| 9.68 | 31.31 | 33.2 | 3 |
| 16.14 | 30.66 | 32.6 | 5 |
| 22.07 | 29.32 | 32.4 | 7 |
| 13.4 | 43.4 | 55 | 3 |
| 22.9 | 43.7 | 51.7 | 5 |
| 29.7 | 39.43 | 48.1 | 7 |
| 5.5 | 54.2 | 66.3 | 1 |
| 17.4 | 56.2 | 73.3 | 3 |
| 29.4 | 55.8 | 73.0 | 5 |
| 40.35 | 53.6 | 73.7 | 7 |

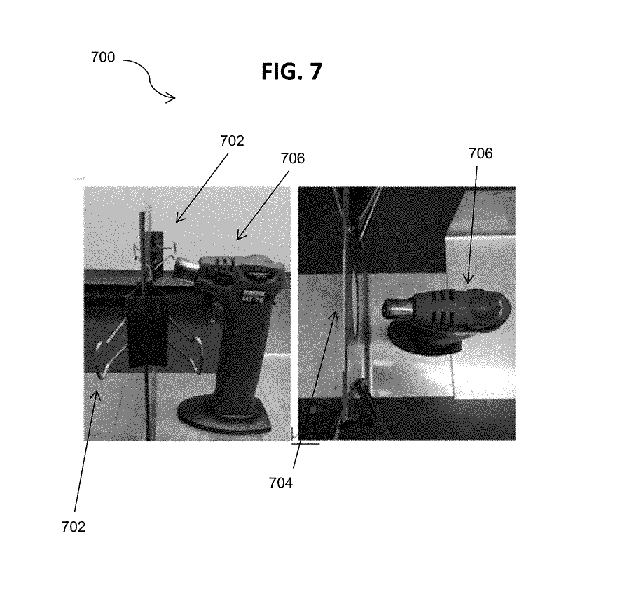

FIG. 7 illustrates an exemplary test setup 700 for flame resistance. The coated samples 704 noted in Table 1 were placed in the middle of two identical metal braces 702 with horizontally centered 1 inch diameter holes at the height of the butane torch 706. A 0.6 inch flame was used to evaluate the flame resistance of the samples for 5 mins.

The flame resistant performances of the coatings after burning for 5 minutes are shown in Table 2. Increasing the CH percentage helps to prevent flame burn through, as indicated by a check mark. Increasing the weight gain also prevents flame burn through.

TABLE 2

| | |
|---|---|
| Weight | Wt. percentage of chitosan (%) |

| gain (%) | 1 | 3 | 5 | 7 |
|---|---|---|---|---|
| 20 | x | ✓ | ✓ | ✓ |
| 30 | x | ✓ | ✓ | ✓ |
| 50 | x | ✓ | ✓ | ✓ |
| 75 | ✓ | ✓ | ✓ | ✓ |

Legend: x Burn through, ✓ did not burn through.

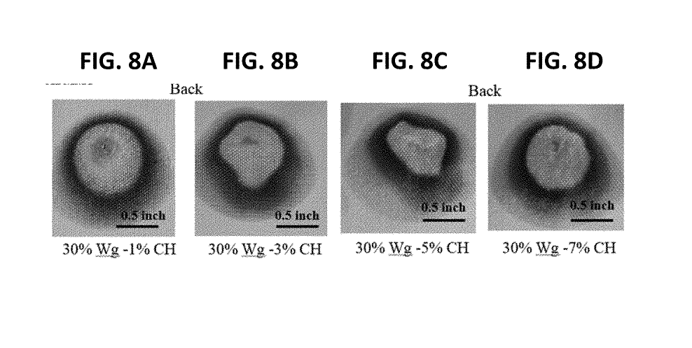

FIGS. 8A-8D illustrate results of the burn test from samples comprising a 30% weight gain as shown in Table 2.

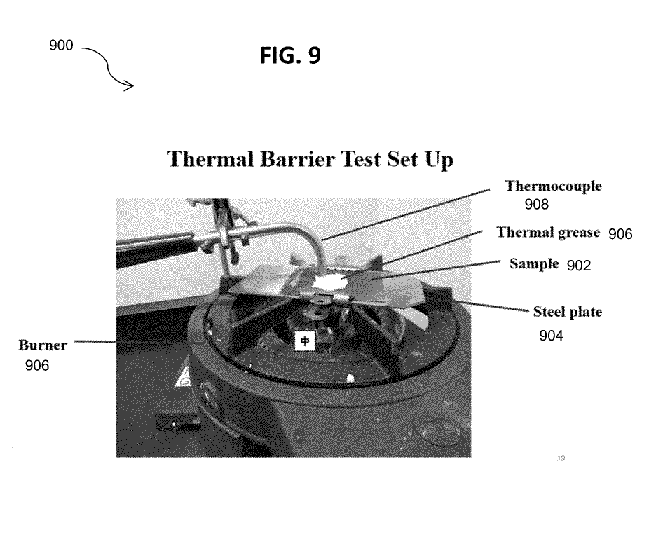

FIG. 9 illustrates an exemplary setup 900 used for thermal barrier testing. The coated samples 902 were rested on the surface of a metal (steel) plate 904 which was placed on top of a burner 906. Two clamps were used to fasten the samples. On the surface of the samples, some thermal grease was used to make sure the homogenous distribution of heat. A thermocouple 908 was immersed into the thermal grease 910 and contacted with the samples 902 to record the temperature. The samples 902 were heated for about 15 minutes in order to evaluate the thermal barrier performance.

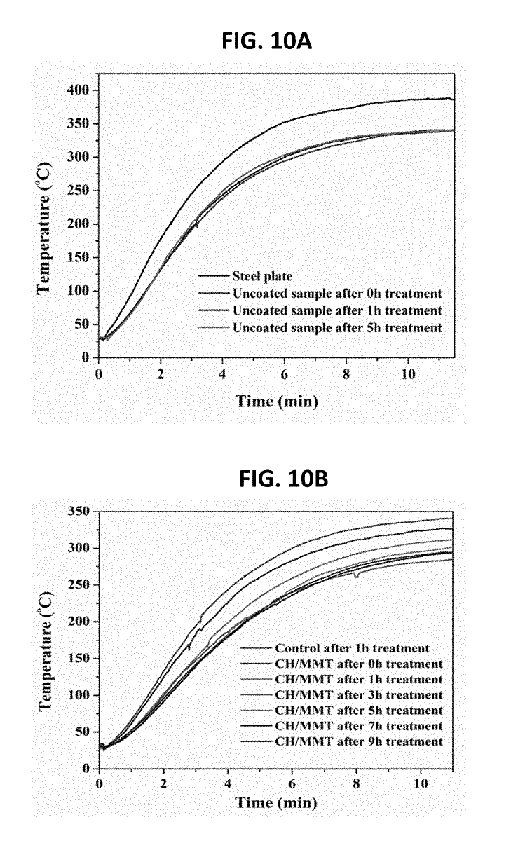

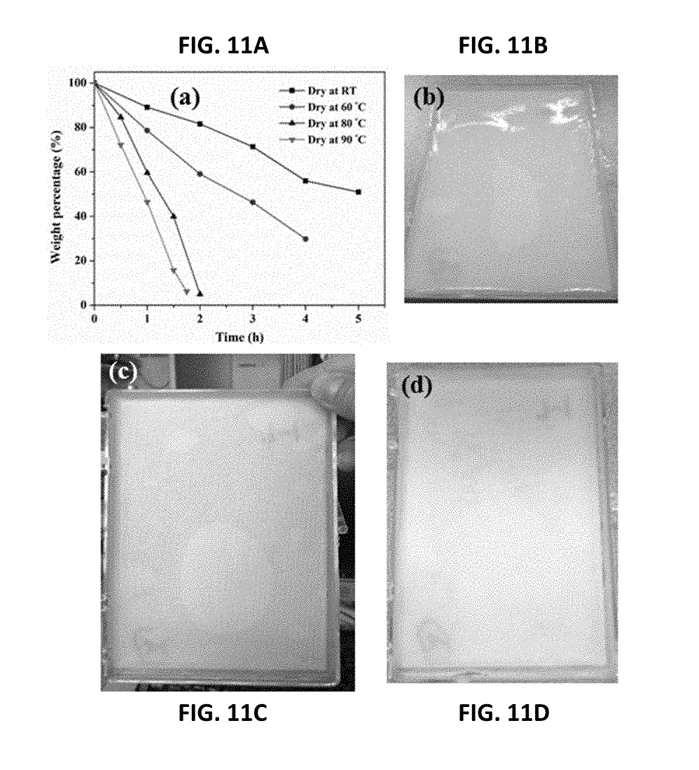

FIGS. 10A and 10B illustrate the heat treatments performed on various coated and uncoated samples that were held at about 500° C. from 1 min-20 min. FIGS. 11A-11D illustrate the results of various drying cycles that were employed in the formation of the discussed thermally-resistant coatings. In particular, FIG. 11A illustrates the weight loss of the coatings, and FIGS. 11B-11D are images of the coated surfaces in the absence of drying (11B), after 20% of the water was removed (11C), and after 50% of the water was removed (11D).

By increasing the dry temperature, the time to make dry coatings greatly decreased. In one example, the results of which are illustrated in 11C, after 0.3 h at 90° C., 0.5 h at 80° C., 1 h at 60° C. and 2 h at room temperature, 20% water was removed and the coatings remain on the surface of laminate. That is, the samples did not exhibit delamination or sliding of the coating even when the samples were tilted. In another example, the results of which are illustrated in FIG. 11D, after 1 h at 90, 1.25 h at 80° C., 3 h at 60° C. and 5 h at room temperature, 50% of the water was removed and the coatings were contacted (touched) without any damage.

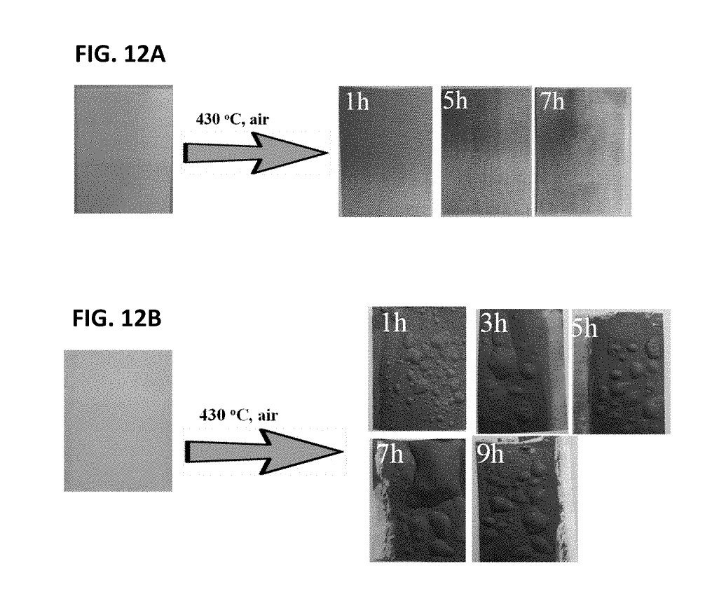

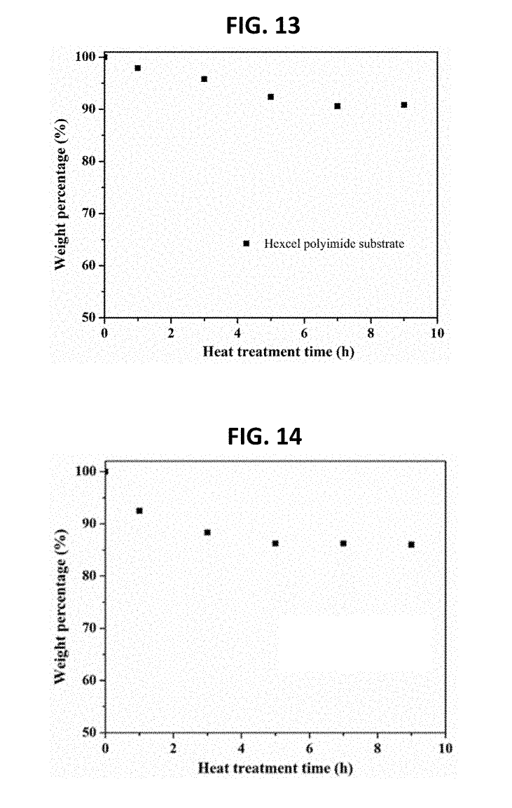

FIGS. 12A and 12B illustrate the coated (12A) and uncoated (12B) samples that were put in a furnace at 430° C. for 1 hour-9 hours. FIG. 13 illustrates the weight % loss of uncoated samples and FIG. 14 illustrates the weight % of the dried coating as a function of the weight of the substrate plus the coating. After heat treatment in a furnace at 430° C., the uncoated laminate (sample) became white, corresponding to the degradation of polyimide as evidenced by the weight loss of the samples. After heat treatment in the furnace at 430° C., the coated samples became black and developed bumps/air pockets. As shown in FIG. 14, the weight of the sample degraded until stabilizing at about 5 h. Although the heat treatment formed bumps in the coatings, the flame did not burn through the coated samples.

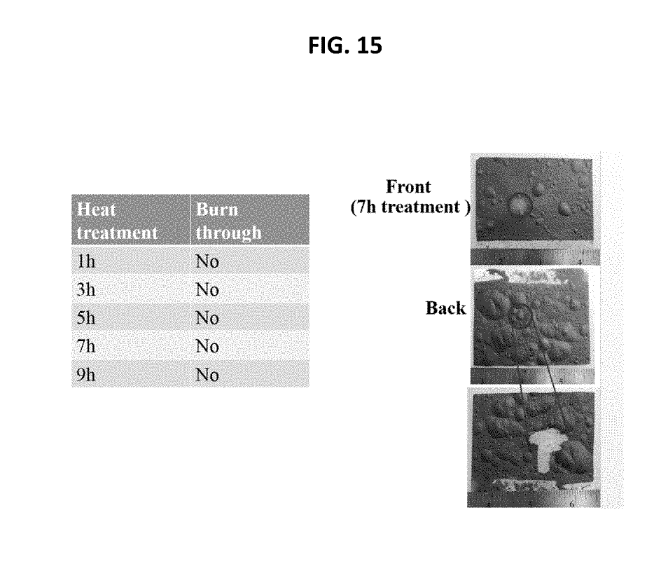

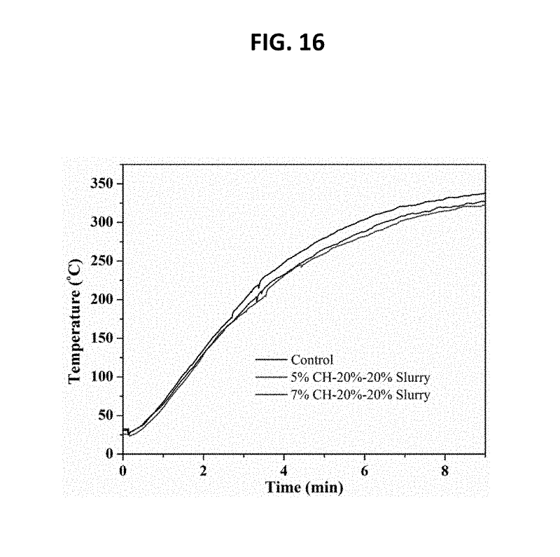

FIG. 15 illustrates the heat treatment and burn through results, as well as images that show that heat treatment improved the thermal barrier performance of CH/MMT samples, as shown in FIG. 16, due to the introduction of an air insulation layer by the bumped structures. In comparison, heat treatment did not influence the thermal barrier performance of uncoated samples of FIG. 12A.

In another example, in a similar fashion to the example described above in the single-sided coating embodiment, a plurality of samples were fabricated by coating a substrate on both sides. In particular, samples were coated on both sides with a dry coating of 5% CH-95% MMT and samples were coated on both sides with a coating solution of 7% CH-93% MMT, both as measured when the coating was dry.

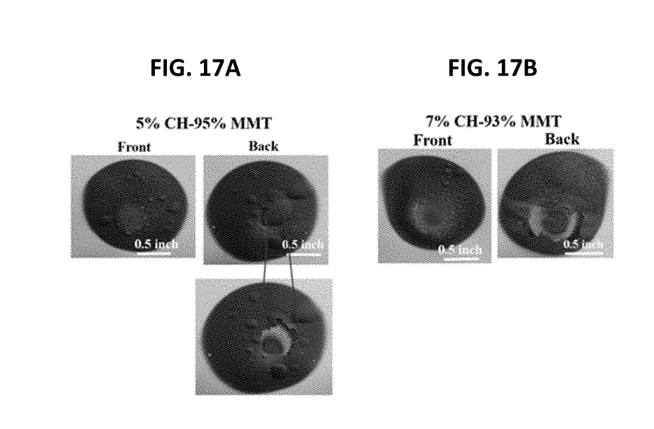

FIG. 16 illustrates the conditions and results of thermal barrier testing for the double-coated samples. FIGS. 17A and 17B illustrate images of the front and back sides of the double-side coated samples 5% CH-95% MMT (17A) and 7% CH-93% MMT (17B).

As shown in FIGS. 17A and 17B, the flame did not burn through the double-sided CH/MMT samples, but the thermal barrier performance of double-side coating (20-30° C. reduction) was slightly worse than that of single-side slurry casting coating (30-40° C. reduction) with the same weight gain.

In another example, samples were coated with trilayers of CH(12%)-MMT/MMT(12%)/CH(12%)-MMT; CH(12%)-MMT/VMT(12%)/CH(12%)-MMT; CH(12%)-VMT/MMT(12%)/CH(12%)-VMT; CH(12%)-VMT/VMT(12%)/CH(12%)-VMT.

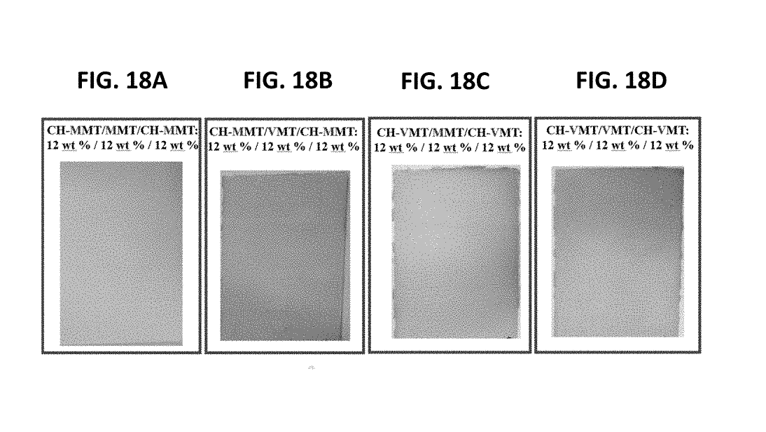

FIGS. 18A-18D illustrate the as-coated trilayers of CH(12%)-MMT/MMT(12%)/CH(12%)-MMT (18A); CH(12%)-MMT/VMT(12%)/CH(12%)-MMT (18B); CH(12%)-VMT/MMT(12%)/CH(12%)-VMT (18C); CH(12%)-VMT/VMT(12%)/CH(12%)-VMT (18D).

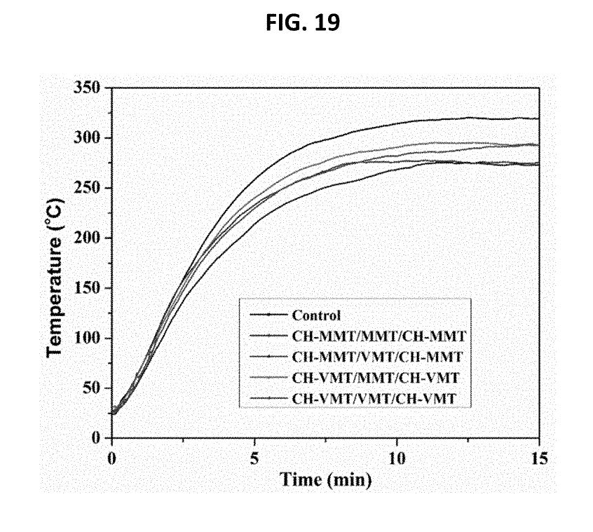

FIG. 19 illustrates the thermal barrier testing performed on the samples described in FIGS. 18A-18D.

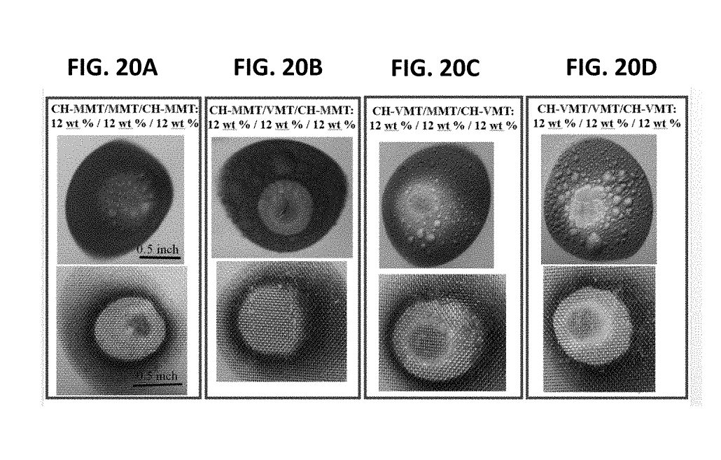

FIGS. 20A-20D illustrate the front and back sides of the samples of CH(12%)-MMT/MMT(12%)/CH(12%)-MMT (19A); CH(12%)-MMT/VMT(12%)/CH(12%)-MMT (19B); CH(12%)-VMT/MMT(12%)/CH(12%)-VMT (19C); CH(12%)-VMT/VMT(12%)/CH(12%)-VMT (19D).

Exemplary embodiments are disclosed and variations, combinations, and/or modifications of the embodiment(s) and/or features of the embodiment(s) made by a person having ordinary skill in the art are within the scope of the disclosure. Alternate embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=R+k*(Rᵤ−Rₗ), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of broader terms such as “comprises,” “includes,” and “having” should be understood to provide support for narrower terms such as “consisting of,” “consisting essentially of,” and “comprised substantially of.” Each and every claim is incorporated into the specification as further disclosure, and the claims are exemplary embodiment(s) of the present invention.

While exemplary embodiments of the invention have been shown and described, modifications thereof can be made by one skilled in the art without departing from the scope or teachings herein. The embodiments described herein are exemplary only and are not limiting. Many variations and modifications of the compositions, systems, apparatus, and processes described herein are possible and are within the scope of the invention. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order and with any suitable combination of materials and processing conditions.

1. A method for manufacturing a thermally-resistant component, the method comprising:
(a) forming a first homogenous coating solution by mixing a first aqueous solution including an cationic polymer and a second aqueous solution including an anionic clay;
(b) applying the first homogenous coating solution to a first side of a substrate.

2. The method of claim 1, wherein the first aqueous solution has a concentration of the cationic polymer between 15 wt. % to about 60 wt. % of the first aqueous solution; and wherein the second aqueous solution has a concentration of the anionic clay between 1.5 wt. % to about 45 wt. % of the second aqueous solution.

3. The method of claim 2, wherein the cationic polymer comprises chitosan.

4. The method of claim 2, wherein the cationic polymer comprises a polysaccharide with at least one nitrogen group.

5. The method of claim 2, wherein the anionic clay comprises vermiculite (VMT) or sodium montmorillonite (MMT).

6. The method of claim 1, wherein (b) comprises applying the first homogenous coating solution to the first side of the substrate with a roll-to-roll coating apparatus, a spraying apparatus, or a dip-coating apparatus.

7. The method of claim 1, further comprising:
(c) applying the first homogenous coating solution to a second side of the substrate.

8. The method of claim 1, further comprising:
(c) allowing the first homogenous coating solution to dry after (b) and form a first layer after (b);
(d) forming a second homogenous coating solution by mixing a third aqueous solution including an cationic polymer and a fourth aqueous solution including an anionic clay;
(e) applying the second homogenous coating solution to the first layer after (c);
(f) allowing the second homogenous coating solution to dry after (e) and form a second layer.

9. The method of claim 1, further comprising:
applying a primer layer to the first side of the substrate before (b);
wherein (b) comprises applying the first homogenous coating solution to the primer layer.

10. The method of claim 9, wherein the primer layer comprises at least one of linear polyethylenimine (L-PEI), branched polyethylenimine (B-PEI), or poly(acrylic acid) (PAA).

11. A thermally-resistant component, comprising:
a polymeric substrate;
a thermally insulating coating mounted to the substrate, wherein the coating comprises a mixture of one or more cationic polymers and one or more anionic clays.

12. The component of claim 11, further comprising a primer layer positioned between the substrate and the coating.

13. The component of claim 12, wherein the primer layer comprises linear polyethylenimine (L-PEI), branched polyethylenimine (B-PEI), poly(acrylic acid) (PAA), or combinations thereof.

14. The component of claim 11, wherein the one or more cationic polymers comprises chitosan.

15. The component of claim 11, wherein the cationic polymer comprises a polysaccharide with at least one nitrogen group.

16. The component of claim 11, wherein the one or more anionic clays comprises vermiculite (VMT), sodium montmorillonite (MMT), or combinations thereof.

17. The component of claim 11, wherein the thermally insulating coating comprises a first layer and a second layer disposed on the first layer, wherein the first layer is positioned between the substrate and the second layer;
wherein the first layer comprises a mixture of one or more cationic polymers and one or more anionic clays; and
wherein the second layer comprises a mixture of one or more cationic polymers and one or more anionic clays.
